(19) United States
(12) Patent Application Publication
(10) Pub. No.: US 2016/0257020 A1
(43) Pub. Date: Sep. 8, 2016

(54) TRUNNION EDGER AND METHOD OF EDGING LUMBER

(71) Applicant: Baxley Equipment Co., Hot Springs, AR (US)

(72) Inventor: Russell R. Kennedy, Hot Springs, AR (US)

(21) Appl. No.: 15/058,927

(22) Filed: Mar. 2, 2016

Related U.S. Application Data
(60) Provisional application No. 62/128,555, filed on Mar. 5, 2015.

(51) Int. Cl. B27B 5/04; B27B 5/36; B27B 1/00

(52) U.S. Cl. CPC B27B 5/04; B27B 1/007; B27B 5/36

(57) ABSTRACT

Provided are a trunnion edger and a method of edging lumber using the trunnion edger. The trunnion edger includes a lineal edger frame, a pivotable saw box constructed to saw lumber within the lineal edger frame, a trunnion mount constructed outside the lineal edger frame for skewing the edger frame around a central axis and in relation to the lineal edger frame, an actuator for skewing the edger frame, and a computer in communication with the actuator

This application claims priority to U.S. provisional patent application Ser. No. 62/128,555, filed 5 Mar. 2015.

### FIELD OF THE INVENTION

The invention relates to a trunnion edger and a method of edging lumber using the trunnion edger.

### BACKGROUND OF THE INVENTION

There are basically two types of optimized edger systems: a) transverse and b) Lineal. In a transverse system, the waned edged boards (flitches) are run through the optimizer transversely (90 degrees to the laser measuring heads), then transferred up to the edger feed table using a conveyor where they are pulled onto the table by fetchers (hydraulic, electric) and skewed about the centerline of the edger feed system (rolls/chain). The saws in the edger are typically set at 4″, 6″, 8, 10″ or 12″ and then the flitch is transferred linearly through the saws, where the strips are sawed off, leaving only the good lumber in the middle of the sawn solution which exits the edger in line or parallel to the feed system of the edger. The edger arbor is always 90 degrees to the thru-feed chain and the saws do not shift in the cut. The sawn piece exits the edger with its edges parallel to the centerline feed of the edger.

The disadvantages of the transverse system include:
1. It requires a complicated feed table, since the piece has to be skewed and accurately placed about the centerline edger feed system on the feed table.
2. The setting speeds are slow.
3. Because of fetcher positioning speeds, gaps between boards can be large, resulting in slower speeds.

Gap distance between boards is the biggest factor regarding edger board thruput speed. Boards/minute=Feed Speed (ft/min)/[Board length (ft)+gap between boards (ft)].

In a Lineal system the boards are transferred onto a roll type feed table and start to proceed lineally immediately because location about the centerline of the feed system is not important. The flitch proceeds down the scan belt (conveyor), through the scanner (optimizer). The optimizer comes up with the best solution and skews the arbor (saw box) to be perpendicular to that solution (not perpendicular to the thru-feed chain as described above). A conventional saw box is shown in FIGS. 1A and 1B [Prior Art]. As the flitch is transferred through the edger, the saws slew in the cut (move transversely left/right) and the skewed sawn solution exits the edger. The sawn solution exits the edger with its edges skewed (not parallel) to the centerline feed of the edger.

The advantages of the lineal system include:
1. There is a simplified feed table, since the piece does not have to be skewed on the table. It is less costly to build than transverse table.
2. There is a shorter gap distance between boards, resulting in higher production rates (Boards/minute).

On a linear edger, the arbor (saw box) has to be skewed to be perpendicular with the sawn solution as described above. At high piece counts, this must happen very quickly in the gap time between the boards. Several methods have been used in the past.

U-joint mounted saws that skew individually to align with the solution are disclosed in U.S. Pat. No. 5,870,936. “Roboguides” that skew the guides (and saws) to align with the solution are disclosed in U.S. Pat. No. 7,861,751. Pivoting the whole saw box 2 about a pivot point 3 as shown in FIGS. 1A and 1B in relation to lineal edger frame has been used. The arbor drive motor is generally removed from the box to reduce the weight and driven to the arbor via a u-joint arrangement.

In the past, the saw box shown in FIGS. 1A and 1B [Prior Art] is pivoted with a low center of gravity with the pivot point located in the center of the saw section directly beneath the saws. The disadvantages include:
1. The pivot is directly under saws, which means trash/strip build up and hang-ups.
2. The saw box is not easily maintained.
3. The saw box is unstable due to a low center of gravity and associated slides to keep it from tipping, which are located beneath the box, making maintenance very difficult.

### SUMMARY OF THE INVENTION

An objective of the invention is to provide an improved lineal edger that solves the problems described above.

The present invention provides a novel structure and method to skew the saw box. The slewing of the saw box can be performed in any conventional manner.

The objectives of the invention can be met by a trunnion edger comprising:
a lineal edger frame;
a pivotable saw box constructed to saw lumber within the lineal edger frame;
a trunnion mount constructed outside the lineal edger frame for skewing the saw box around a central axis and in relation to the lineal edger frame;
an actuator for skewing the saw box; and
a computer in communication with the actuator.

The objectives of the invention can also be met by a method of cutting using a trunnion edger comprising:
providing a trunnion edger comprising:
   a lineal edger frame;
   a pivotable saw box constructed to saw lumber within the lineal edger frame;
   a trunnion mount constructed outside the lineal edger frame for skewing the saw box around a central axis and in relation to the lineal edger frame;
   an actuator for skewing the saw box; and
   a computer in communication with the actuator;
measuring a lumber piece being conveyed on a conveyor using an optimizer connected to the computer;
skewing the saw box using the actuator; and
cutting the lumber piece using the saw box.

### BRIEF DESCRIPTION OF THE DRAWINGS

FIGS. 1A and 1B [Prior Art] illustrate a prior art saw box.

FIGS. 2A and 2B illustrate an improved lineal edger according to the present invention.

### DETAILED DESCRIPTION OF THE INVENTION

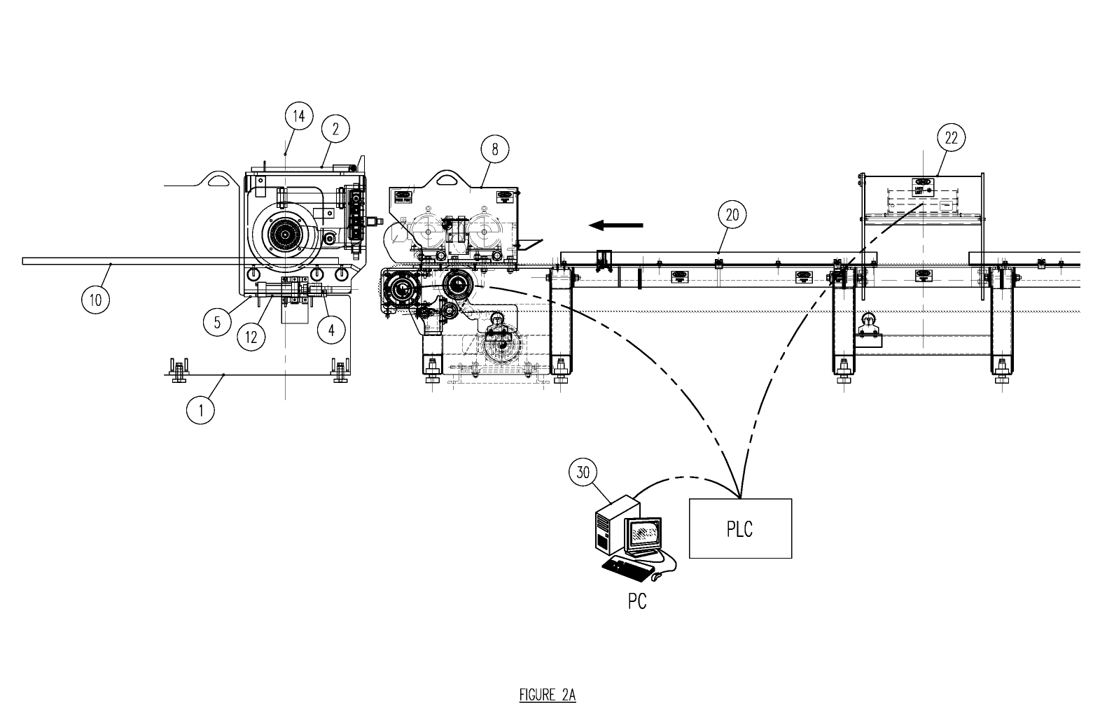

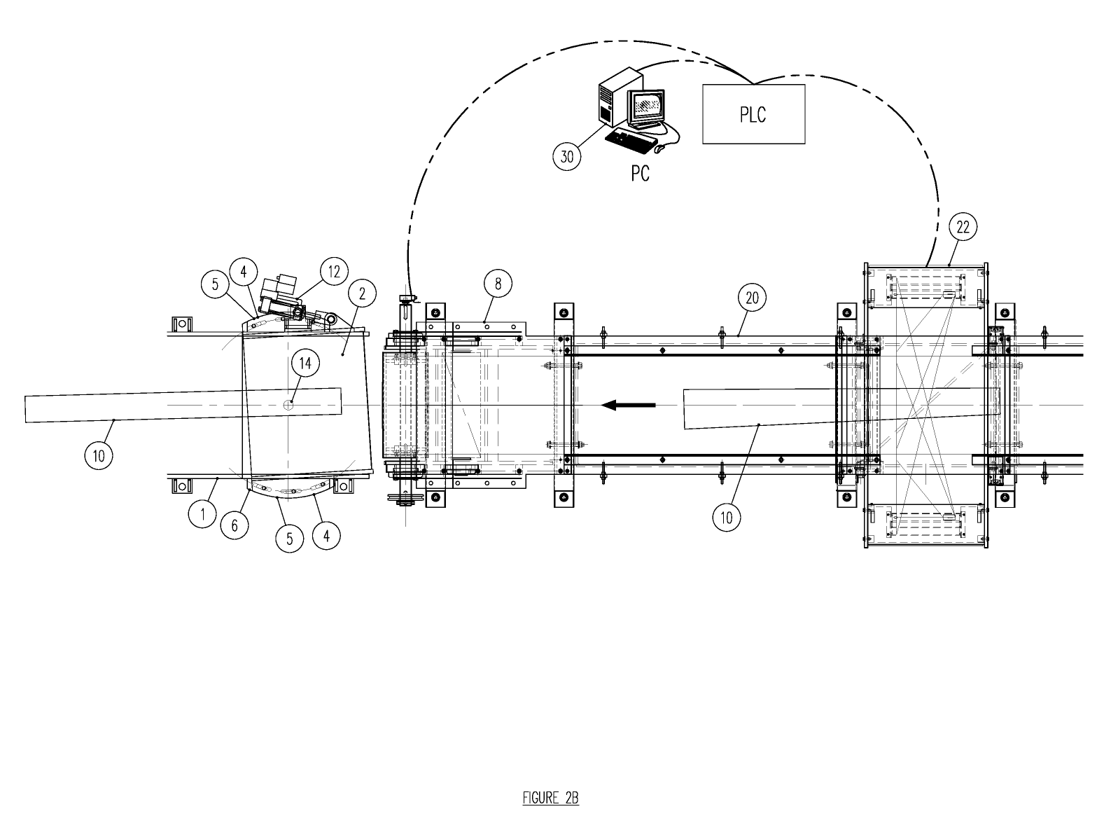

The invention will be explained without being limited by the attached drawings. An improved lineal edger is shown in FIGS. 2A and 2B, referred to as the TrunnionEdger. “Trunnion” plates located outside of the edger frame 1 to allow the saw box to articulate or skew directly about the center axis 14 of the saw box. The advantages of the present invention include:
1. There is no pivot point underneath saws, so dropout area for strips and sawdust is unobstructed, which results in less downtime caused by hang-ups.
2. The device has a higher center of gravity and less weight to articulate, resulting in quicker sets and higher piece counts.
3. The higher center of gravity provides more stability.
4. The device is easier to maintain since all parts are located outside the edger in an easily accessible location.

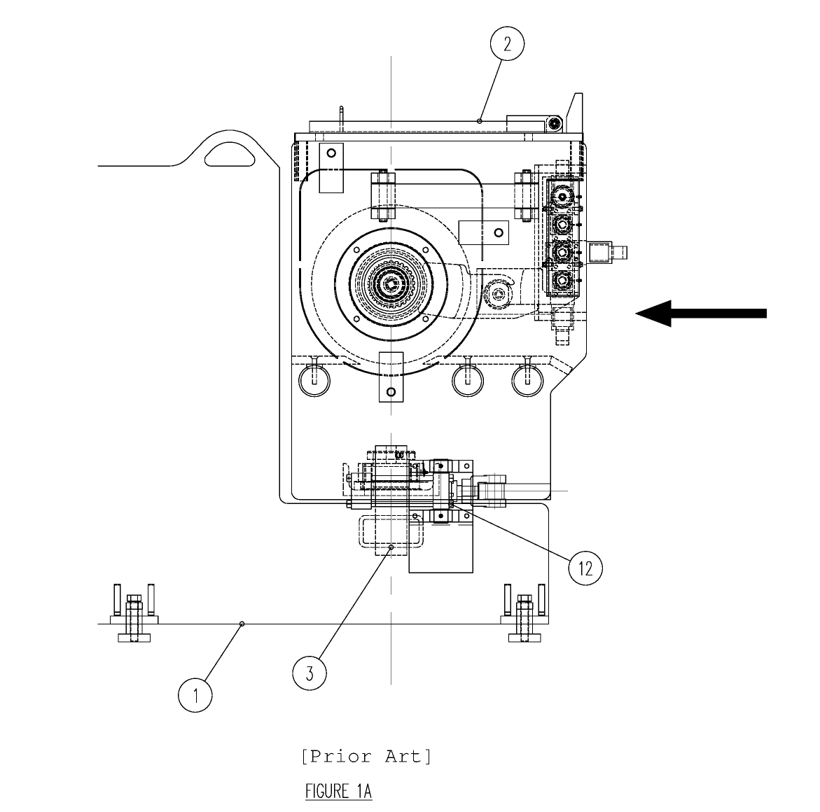

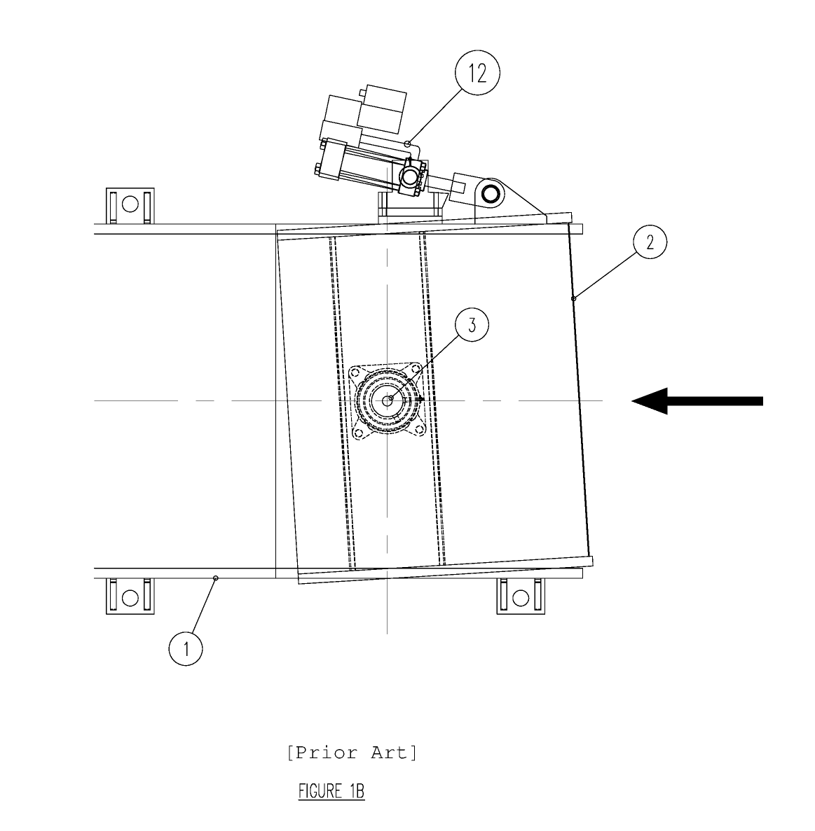

Conventional saw boxes for Lineal edgers, such as shown in FIGS. 1A and 1B [Prior Art] are now well known. Lineal edgers have a lineal edger frame 1 that supports a pivoting saw box 2. The saw box 2 is pivotably connected to the frame 2 by a central bearing (pivot) 3 located below the saw box 2 in a central portion of the saw box 2. The saw box 2 comprises at least one saw and a motor constructed to the power the saw. The saw box 2 also includes an actuator or motor 12 to pivot the saw box 2 about a central axis 14. The lineal edger usually includes a computer for controlling the operation of the edger, including pivoting (skewing) the saw box 2.

The improved lineal edger shown in FIGS. 2A and 2B includes a lineal edger frame 1 that supports a pivoting saw box 2. There is no pivot located in a central location (central axis 14) below the saw box 2. The saw box 2 is connected to the frame 1 by two trunnion mounts 4, one located on each side of the frame 1. The trunnion mounts 4 each comprise plates 6 and bearing surfaces 5. The trunnion mounts 4 allow the saw box 2 to pivot about the central axis 14, for example by at least 5 degrees, referred to as skewing.

The bearing surfaces 5 can be any suitable structure, such as sliding surfaces, cam roll, bearings, wheels, or other. Preferably, the bearing surfaces 5 comprise slides, which do not require grease or oil. Preferred slides are plastic plates. Any suitable plastic or other material for the sliding surface can be used, such as nylon plastics, Nylatron.

The saw box 2 is skewed by an actuator 12. The actuator 12 can be hydraulic cylinder, electrically actuated cylinder, geared servo motor with feedback mechanism, or other device. Saw box 2 typically only needs to rotate (skew) about plus or minus 5 degrees. Accuracy of skew is required. The actuator 12 is connected to and controlled by a computer 30, which can be any suitable computer control system. Control systems are now well known. A commercial example of the computer 30 is an A.B.ControLogix 5000 series.

Slewing of the saws can be done in any conventional manner using any conventional structure.

The flitch (lumber) 10 proceeds down the scan belt (conveyor) 20, through the scanner (optimizer) 22 that is connected to the computer 30. The optimizer 22 comes up with the best solution and skews the saw box 2 to the desired position using the actuator 12. The filtch 10 is transferred from the conveyor 20 to a saw box infeed module 8 that stabilizes the filtch 10 as it moves through the edger and is cut. The infeed module 8 is connected to the computer 30. Any conventional infeed module 8, conveyor 20, and optimizer 22 can be used in the present invention. As the flitch 10 is transferred through the edger, the saws slew in the cut (move transversely left/right) and the skewed sawn board exits the edger. The sawn board exits the edger with its edges skewed (not parallel) to the centerline feed of the edger.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A trunnion edger comprising:
a lineal edger frame;
a pivotable saw box constructed to saw lumber within the lineal edger frame;
a trunnion mount constructed outside the lineal edger frame for skewing the saw box around a central axis and in relation to the lineal edger frame;
an actuator for skewing the saw box; and
a computer in communication with the actuator.

2. The trunnion edger according to claim 1, wherein there is no pivot mount located below a central portion of the saw box.

3. The trunnion edger according to claim 1, further comprising a conveyor constructed to convey lumber to the pivotable saw box.

4. The trunnion edger according to claim 3, further comprising an infeed module constructed to stabilize the lumber during sawing and being connected to the computer.

5. The trunnion edger according to claim 1, wherein the trunnion mount comprises bearing surfaces disposed on opposing sides of the lineal edger frame.

6. The trunnion edger according to claim 5, wherein bearing surfaces comprise at least one of sliding surfaces, cam roll, bearings, or wheels.

7. The trunnion edger according to claim 5, wherein bearing surfaces comprise slides that are free of grease and oil.

8. The trunnion edger according to claim 5, wherein bearing surfaces comprise plastic plates.

9. A method of cutting using a trunnion edger comprising:
providing a trunnion edger comprising:
a lineal edger frame;
a pivotable saw box constructed to saw lumber within the lineal edger frame;
a trunnion mount constructed outside the lineal edger frame for skewing the saw box around a central axis and in relation to the lineal edger frame;
an actuator for skewing the saw box; and
a computer in communication with the actuator;
measuring a lumber piece being conveyed on a conveyor using an optimizer connected to the computer;
skewing the saw box using the actuator; and
cutting the lumber piece using the saw box.

10. The method according to claim 9, further comprising using an infeed module to stabilize the lumber piece during cutting.

11. The method according to claim 9, wherein the optimizer determines a sawn solution and the computer skews the saw box to be perpendicular with the sawn solution.

12. The method according to claim 9, wherein there is no pivot mount located below a central portion of the saw box.

13. The method according to claim 9, wherein the trunnion mount comprises bearing surfaces disposed on opposing sides of the lineal edger frame, the method comprising skewing the saw box on the bearing surfaces.

14. The method according to claim 13, wherein bearing surfaces comprise at least one of sliding surfaces, cam roll, bearings, or wheels.

15. The method according to claim 13, wherein bearing surfaces comprise slides that are free of grease and oil.

16. The method according to claim 5, wherein bearing surfaces comprise plastic plates.
